(19) United States
(12) Patent Application Publication
(10) Pub. No.: US 2002/0075115 A1
(43) Pub. Date: Jun. 20, 2002

(54) Transformer bobbin

(76) Inventors: Ming Yeh, Banchiau City (TW); Heng Cheng Chou, Shinjuang City (TW); Chen-Feng Wu, Bade City (TW); Jen Chieh Huang, Taoyuan City (TW)

Correspondence Address: BIRCH STEWART KOLASCH & BIRCH, PO BOX 747, FALLS CHURCH, VA, 22040-0747, US

(21) Appl. No.: 09/962,165

(22) Filed: Sep. 26, 2001

(30) Foreign Application Priority Data
Dec. 12, 2000 (TW) 89218848

(51) Int. Cl. H01F 27/30

(52) U.S. Cl. 336/198

(57) ABSTRACT

The transformer bobbin of the present invention includes a tubular body, a first partition wall, at least one second partition wall, at least one third partition wall and pins. The first partition wall is formed on the surface of the tubular body. The first partition wall includes a first flange having a thinner section for providing winding of a wire. The first partition wall separates a primary side from a secondary side. The second partition wall, parallel to the first partition wall, is formed on the surface of the tubular body. The second partition wall includes a second breach and a second flange having a second cut corner formed thereon. The third partition wall, interposed between the adjacent second partition walls, includes a third breach and a third flange having a third cut corner formed thereon. There is a horizontal height difference exists between the second cut corner and the third cut corner.

### BACKGROUND OF THE INVENTION

1. Field of the Invention

The present invention relates to a bobbin, and more particularly to a transformer bobbin.

2. Description of the Prior Art

A conventional transformer bobbin 10, as shown in FIG. 1(a) and FIG. 1(b), is composed of a tubular body 20 and a plurality of partition wall 30. Among these, the tubular body 20 is used to accommodate a strip of core, and providing winding of wire formed thereon. The wire includes the wire of primary side(not shown) and the wire of secondary side 60, thereafter called wire 60 for short.

Still referring to FIG. 1(a) or FIG. 1(b), the partition wall 30 is formed on the surface of the tubular body 20 so as to isolate the primary side, the secondary side and a plurality of winding grooves located on the secondary side. The partition wall 30 has a wire guiding notch 31 formed on a section of that. Besides, the partition wall 30 has a flange 33 shown in FIG. 1(a) or a cut corner 35 shown in FIG. 1(b). It should be noted that the flanges 33 and the cut corners 35 are arranged in line, on the same side and the same level. That is, there is no horizontal height difference between the flanges 33 and the cut corners 35.

Still referring to FIG. 1(a) or FIG. 1(b), the secondary side of the tubular body 20 further has 2 pins, including a start terminal 50a and an ending terminal 50b. Among these, the start terminal 50a is used as a terminal from which winding of wire 60 is started and the ending terminal 50b is used as a terminal at which winding of wire 60 is terminated. During the wire 60 extends from the start terminal 50a to the ending terminal 50b, the wire 60 passes the winding groove so as to form windings. Once the winding number of a winding groove conforms to a predetermined value, the wire 60 extends to the next adjacent winding groove to form another winding. In this manner, selectiveness of voltage is formed. For the simplification of drawing, the present invention merely depicts the wire 60 adjacent to the start terminal 50a and the ending terminal 50b.

Still referring to FIG. 1(a) or FIG. 1(b), during the winding is accomplished and the wire 60 goes back to the ending terminal 50b, it is dangerous if the wire 60 lacks of support and fix since the terminal of the wire 60 is on the opposite of the secondary side and thus far from the ending terminal 50b. The wire 60 is liable to be cut off.

The wire 60 closes to the outer portion having the highest voltage of the winding and short circuit, resulted from undesired displacement, thus is liable to occur even though the wire 60 is still continuous.

Prior art proposed for solving the above problem includes a step of twisting the wire 60 after which extends from the opposite of the secondary side to the ending terminal 50b. The step of twisting is used to strengthen the wire 60 and may solve the problem. However, the step is additional and fails to fix the wire 60.

Alternatively, the above-mentioned flange 33 or the cut corner 35 is provided to support and fix the wire 60. However, the bobbin having the cut corners 35 fails to provide the wire 60 with overall support and any fix. For example, the cut corner 35 can prevent the displacement of the wire 60 caused by the external force form the right side of drawing but fails to prevent the displacement of the wire 60 caused by the external force form the left side of drawing. On the other hand, the bobbin having the flange 33 merely supports the wire 60 but fails to provide fix.

Accordingly, there has been a strongly felt need for a novel bobbin providing the wire with support and fix to solve the above-mentioned problem. Besides, it is desired that the manufacturing process of the transformer using the bobbin is simplified.

### SUMMARY OF THE INVENTION

The main object of the present invention is to overcome the aforementioned problems. Besides, the present invention omits one manufacturing step compared to prior art.

The present invention includes a tubular body, a first partition wall , at least one second partition wall , at least one third partition wall , a plurality of pins of primary side and two pins of secondary side. The first partition wall is formed on the surface of the tubular body so as to separate the primary side from the secondary side. Additionally, the first partition wall has a first flange having a thinner section used to provide winding of the wire. The second partition walls parallel to the first partition wall are also formed on the surface of the secondary side of the tubular body. Each of the second partition walls has a second breach and a second flange having a second cut corner formed thereon. Each of the third partition walls is interposed between the adjacent second partition walls. The third partition walls has a third breach and a third cut corner formed thereon. The second cut corner and the third cut corner are on the same side but not on the same level.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 (a) is a conventional transformer bobbin

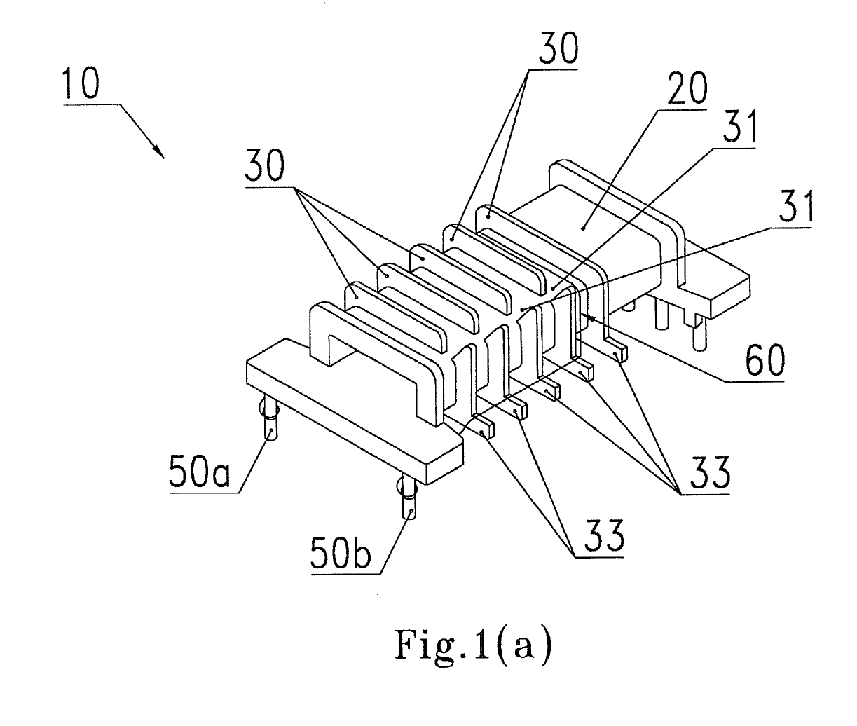

FIG. 1 (b) is another conventional transformer bobbin

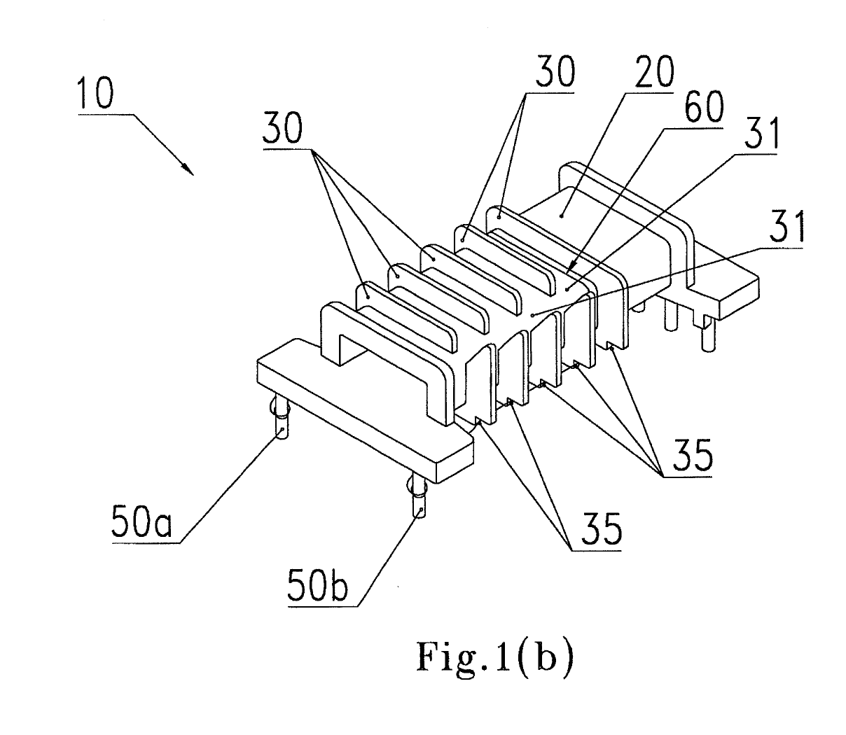

FIG. 2 is the transformer bobbin according to the present invention;

FIG. 3(a) is first embodiment of winding according to the present invention ; and

FIG. 3(b) is second embodiment of winding according to the present invention.

### DESCRIPTION OF THE PREFERRED EMBODIMENT

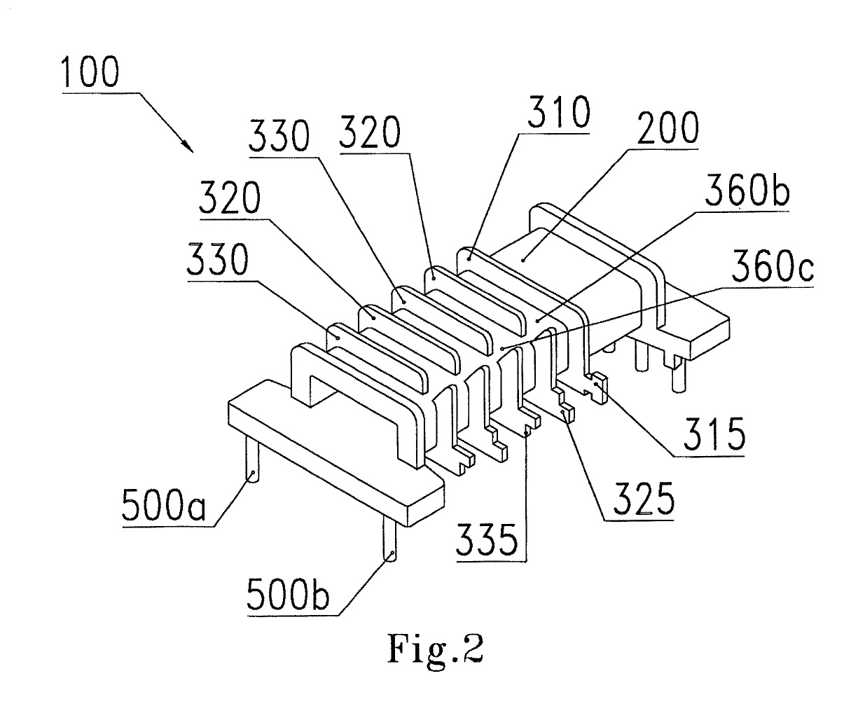

Referring to FIG. 2, the present invention comprises a tubular body 200, a first partition wall 310, at least one second partition wall 320, at least one third partition wall 330, a plurality of pins of primary side and two pins of secondary side 50a and 50b. Among these, the tubular body 200 is used to accommodate a strip of core (not shown), and provide winding of wire formed thereon so as to form a transformer. The wire includes the wire of primary side (not shown) and the wire of secondary side 600, thereafter called wire 600 for short. The first partition wall 310 is formed on the surface of the tubular body 200 so as to separate the primary side from the secondary side. Additionally, the first partition wall 310 has a first flange having a thinner section 315 used to provide winding of the wire 600.

Still referring to FIG. 2, the second partition walls 320 parallel to the first partition wall 310 are also formed on the surface of the secondary side of the tubular body 200. Each of the second partition walls 320 has a second breach 360b and a second flange having a second cut corner 325 formed thereon. Each of the third partition walls 330 is interposed between the adjacent second partition walls 320 such that a plurality of winding grooves are formed on the secondary side of the tubular body 200. That is, along the direction from the primary side extending to the secondary side, the first partition walls 310 is followed by the second partition walls 320; and the second partition walls 320 is followed by the third partition walls 330. The third partition walls 330 has a third breach 360c and a third flange having a third cut corner 335 formed thereon. The second breach 360b and the third breach 360c are arranged in line. It should be noted that the second cut corner 325 and the third cut corner 335 are on the same side but not on the same level. That is, there is horizontal height difference existing between the second cut corner 325 and the third cut corner 335.

The first embodiment of winding

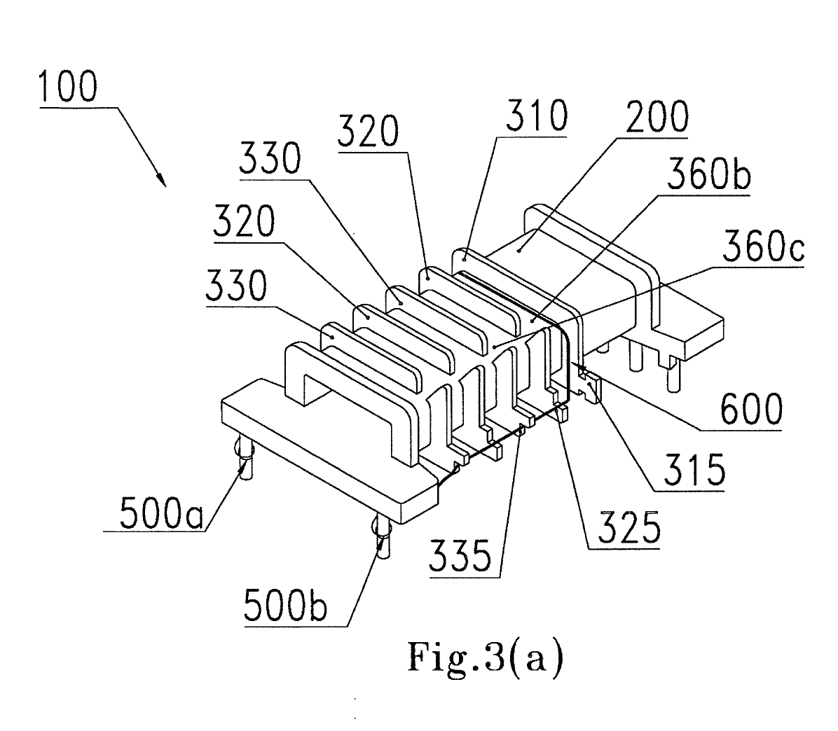

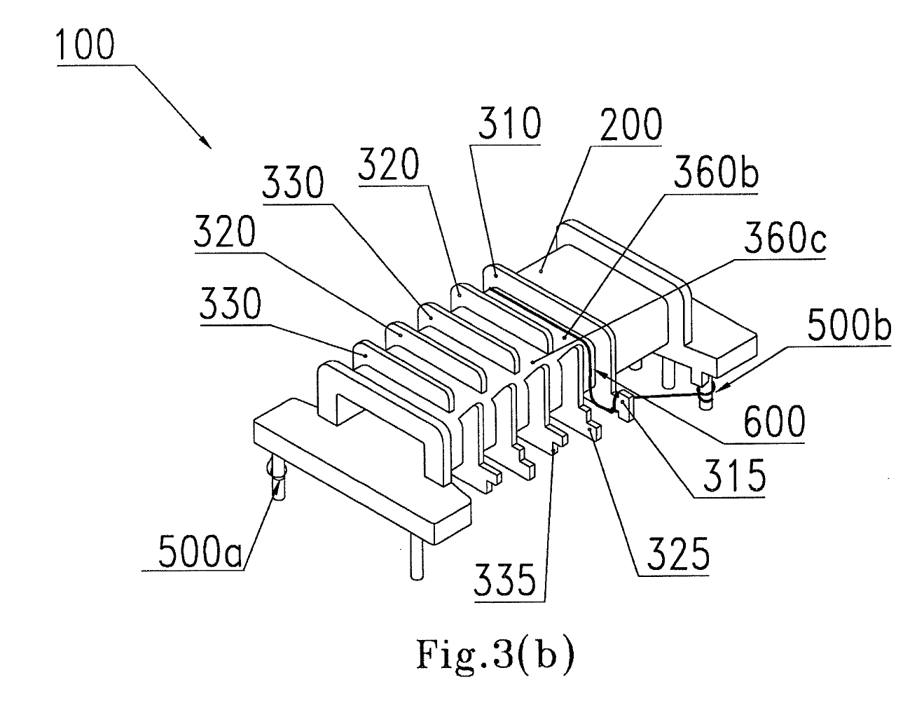

Referring to FIG. 3(a), the bobbin 100 includes a start terminal 500a and an ending terminal 500b. In the first embodiment, the pins 500a and 500b are arranged in the same geometric side to fit with the layout of the PCB where the transformer using the bobbin mounted thereon. Among these, the start terminal 500a is used as a terminal from which winding of wire 600 is started and the ending terminal 500b is used as a terminal at which winding of wire 600 is terminated. During the wire 600 extends from the start terminal 500a to the ending terminal 500b, the wire 600 passes the winding groove so as to form windings. Once the winding number of a winding groove conforms to a predetermined value, the wire 600 extends to the next adjacent winding groove through the second breach 360b or the third breach 360c to form another winding. In this manner, selectiveness of voltage is formed For the simplification of drawing, the drawing of the present invention omits the wire formed on the winding groove and thus merely depicts the wire 600 adjacent to the start terminal 500a and the ending terminal 500b.

Still referring to FIG. 3(a), during the winding is accomplished and the wire 600 goes back to the ending terminal 500b, the wire 600 passes over the second cut corner 325; pass under the third cut corner 335 and then ultimately fastened to the ending terminal 500b. In this manner, the horizontal height difference existing between the second cut corner 325 and third cut corner 335 provides the wire 600 with excellent support and fix.

The second embodiment of winding

Referring to FIG. 3(b), the bobbin 100 includes a start terminal 500a and an ending terminal 500b. In the second embodiment, the pins 500a and 500b are geometrically arranged in the opposite side to fit with the layout of the PCB where the transformer using the bobbin mounted thereon. Among these, the start terminal 500a is used as a terminal from which winding of wire 600 is started and the ending terminal 500b is used as a terminal at which winding of wire 600 is terminated. During the wire 600 extends from the start terminal 500a to the ending terminal 500b, the wire 600 passes the winding groove so as to form windings. Once the winding number of a winding groove conforms to a predetermined value, the wire 600 extends to the next adjacent winding groove through the second breach 360b or the third breach 360c to form another winding. In this manner, selectiveness of voltage is formed. For the simplification of drawing, the drawing of the present invention omits the wire formed on the winding groove and thus merely depicts the wire 600 adjacent to the start terminal 500a and the ending terminal 500b.

Still referring to FIG. 3(b), during the winding is accomplished and the wire 600 extends to the ending terminal 500b, winding of the wire 600 wound on the thinner section 315 is thus formed and then the wire 600 is ultimately fastened to the ending terminal 500b. In this manner, the thinner section 315 provides the wire 600 with excellent support and fix.

Referring to FIG. 3(a) or FIG. 3(b), the present invention provides the wire with an overall fixing and support. Since the wire 600 wound on the thinner section 315 obtains an excellent support, the present bobbin can resist the horizontal external force. The present bobbin further resists the vertical external force by means of the second partition walls 320 or the third partition walls 330. In this manner, the wire is not liable to be cut off. Besides, since the present invention provides the wire with an excellent fixing and support, twisting wire is not required. That is, the present invention omits one manufacturing step compared to prior art.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A transformer bobbin, comprising
a tubular body;
a first partition wall, formed on the surface of said tubular body, said first partition wall including a first flange having a thinner section used to provide winding of a wire, said first partition wall separating a primary side from a secondary side
at least one second partition wall, parallel to said first partition wall, formed on the surface of said tubular body, said second partition walls including a second breach and a second flange having a second cut corner formed thereon;
at least one third partition wall, interposed between said adjacent second partition walls, said third partition wall including a third breach and a third flange having a third cut corner formed thereon, wherein a horizontal height difference exists between said second cut corner and said third cut corner;
a plurality of pins of primary side; and
two pins of secondary side.

2.The transformer bobbin according to claim 1, further comprises a first wire wound on said primary side.

3.The transformer bobbin according to claim 1, further comprises a second wire wound on said second side.

4.The transformer bobbin according to claim 1, wherein said second side of said bobbin further comprises a start terminal and an ending terminal.

5.The transformer bobbin according to claim 4, wherein said start terminal and said ending terminal are geometrically arranged in an opposite side of said bobbin.

6.The transformer bobbin according to claim 4, wherein said start terminal and said ending terminal are geometrically arranged in the same side of said bobbin.

7.The transformer bobbin according to claim 1, wherein said second breach and said third breach are on the same side and arranged in line.

8.The transformer bobbin according to claim 1, wherein said tubular body is used to accommodate a strip of core.

9.The transformer bobbin according to claim 1, wherein said second partition wall and said third partition wall are used to form a plurality of winding grooves.
